(19) United States
(12) Patent Application Publication
(10) Pub. No.: US 2013/0336741 A1
(43) Pub. Date: Dec. 19, 2013

(54) Bolt Assembly for Wiper Device of Vehicle

(71) Applicant: DONGYANG MECHATRONICS CORP., Incheon (KR)

(72) Inventors: Wi Yeong Park, Incheon (KR); Jong Hyun Oh, Incheon (KR)

(73) Assignee: Dongyang Mechatronics Corp., Incheon (KR)

(21) Appl. No.: 13/804,879

(22) Filed: Mar. 14, 2013

(30) Foreign Application Priority Data
Jun. 18, 2012 (KR) 10-2012-0065238

(51) Int. Cl. B60S 1/04

(52) U.S. Cl. CPC B60S 1/0441
USPC 411/337

(57) ABSTRACT

Provided is a bolt assembly for a wiper device of a vehicle. The bolt assembly includes: a damping member in which a penetration hole is formed and that is detachably coupled to an assembly unit; a bush that correspondingly fits a penetration hole; a bolt member that is disposed to penetrate a hollow of the bush; a washer that is assembled to the bolt member; and a separation prevention member that is assembled to the bolt member to prevent the bolt member from being separated to an upper side of the hollow, wherein the separation prevention member comprises: a flange portion that is caught on the lower surface of the bush; and a pressure portion that extends from the flange portion toward the longitudinal direction of the bolt member.

### CROSS-REFERENCE TO RELATED PATENT APPLICATION

This application claims the benefit of Korean Patent Application No. 10-2012-0065238, filed on Jun. 18, 2012, in the Korean Intellectual Property Office, the disclosure of which is incorporated herein in its entirety by reference.

### BACKGROUND OF THE INVENTION

1. Field of the Invention

The present invention relates to a wiper device for a vehicle, and more particularly, to a bolt assembly that is adopted to fix a wiper device to a car body.

2. Description of the Related Art

A windshield of a vehicle needs to be maintained clean to secure a clear front view of a driver during driving and drive safely. However, since the atmosphere includes lots of dust, if the windshield is not periodically cleaned, foreign substances such as dust gather on the windshield, and thus, a driver's view is obstructed. In particular, a driver's front view becomes blurred due to rain streaming down the windshield. Thus, a wiper device is provided to clean the windshield when necessary.

Such a wiper device is formed in a modular form and is fixed to a car body by a coupling unit such as bolts or the like. An example of a structure of the wiper device is disclosed in Korean patent publication No. 2007-0061928. A wiper device formed in a module form to effectively fix the wiper device to a car body includes a wiper motor 1, a linkage 2, a wiper arm 3, and a wiper blade 4, as illustrated in FIG. 1. In particular, a bolt 5 is generally used to fix the wiper device including the above-stated components to a car body. Generally, vehicle assembly manufacturers do not directly produce a component having a modular form, such as a wiper device, but outsources the component having a modular form. Accordingly, a place where a wiper device is manufactured and a place where the wiper device is assembled onto a car body are generally different. Thus, a wiper device is sent to a vehicle assembly manufacturer after the wiper device is assembled in a modular form. In addition, to effectively assemble the wiper device onto a car body, the vehicle assembly manufacturer requires a wiper device to which the bolt 5 was already coupled. However, as illustrated in FIG. 1, the bolt 5 may easily separate from the wiper device, and thus may be lost during transportation or may unexpectedly separate from the wiper device in an assembly process.

### SUMMARY OF THE INVENTION

The present invention provides a bolt assembly for a wiper device of a vehicle that is not separated from a wiper device during handling at a vehicle assembly manufacturer as well as during transportation of the wiper device by improving a structure of a bolt for fixing the wiper device to a car body.

According to an aspect of the present invention, there is provided a bolt assembly for a wiper device of a vehicle, the bolt assembly including: a damping member in which a penetration hole is formed in a central portion thereof and that is detachably coupled to an assembly unit disposed in the wiper device, wherein the damping member includes a rubber material; a bush that correspondingly fits an inner circumference surface of the penetration hole to be fixed to the damping member and includes a hollow; a bolt member that is disposed to penetrate the hollow of the bush, has an external diameter smaller than an internal diameter of the hollow, wherein the bolt member includes a male screw portion formed on an outer circumference surface of a portion protruding under a lower surface of the hollow; a washer that is assembled to the bolt member to prevent the bolt member from being separated to a lower side of the hollow and thus is caught on an upper surface of the bush; and a separation prevention member that is assembled to the bolt member to prevent the bolt member from being separated to an upper side of the hollow and thus is caught on a lower surface of the bush, wherein the separation prevention member includes: a flange portion that is caught on the lower surface of the bush and includes an assembly hole, through which the male screw portion of the bolt member penetrates, in the central portion of the flange portion; and a pressure portion that extends from the flange portion toward the longitudinal direction of the bolt member and partially surrounds the male screw portion of the bolt member.

The separation prevention member may further include a hook protruding toward the male screw portion, which is disposed on an upper portion of the pressure portion.

The separation prevention member may further include an auxiliary hook that is formed to protrude from an inner circumference surface of the assembly hole toward the male screw portion and not to overlap with the hook when seen along the longitudinal direction of the bolt member.

The pressure portion may include a plurality of pressure portions that are disposed spaced apart from each other along the circumference of the bolt member.

The auxiliary hook may include a plurality of auxiliary hooks

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram for explaining a schematic structure of a conventional wiper device;

FIG. 2 is a diagram showing a wiper device in which a bolt assembly according to an embodiment of the present invention is adopted;

FIG. 3 is a perspective view showing that the volt assembly is disassembled from the wiper device illustrated in FIG. 2;

FIG. 4 is a schematic plan view of portion “A” illustrated in FIG. 2;

FIG. 5 is a cross-sectional view taken along line V-V illustrated in FIG. 4;

FIG. 6 is a cross-sectional view taken along line VI-VI illustrated in FIG. 4;

FIG. 7 is a schematic perspective view of a separation prevention member illustrated in FIG. 5;

FIG. 8 is a diagram for explaining a separation prevention operation in a case where the bolt assembly illustrated in FIG. 2 contacts a car body panel; and

FIGS. 9 and 10 are diagrams sequentially showing a process of assembling the wiper device to a car body panel by using the bolt assembly illustrated in FIG. 2.

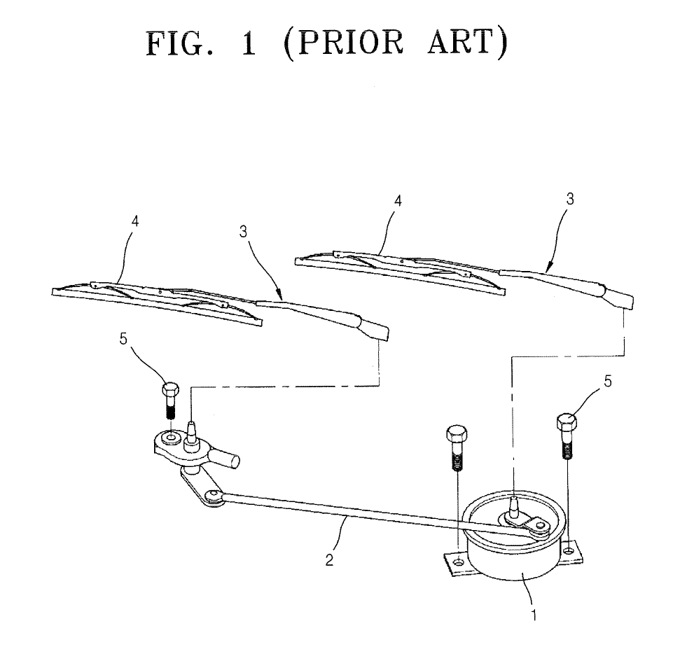

### DETAILED DESCRIPTION OF THE INVENTION

Hereinafter, an embodiment of the present invention will be described with reference to accompanying drawings.

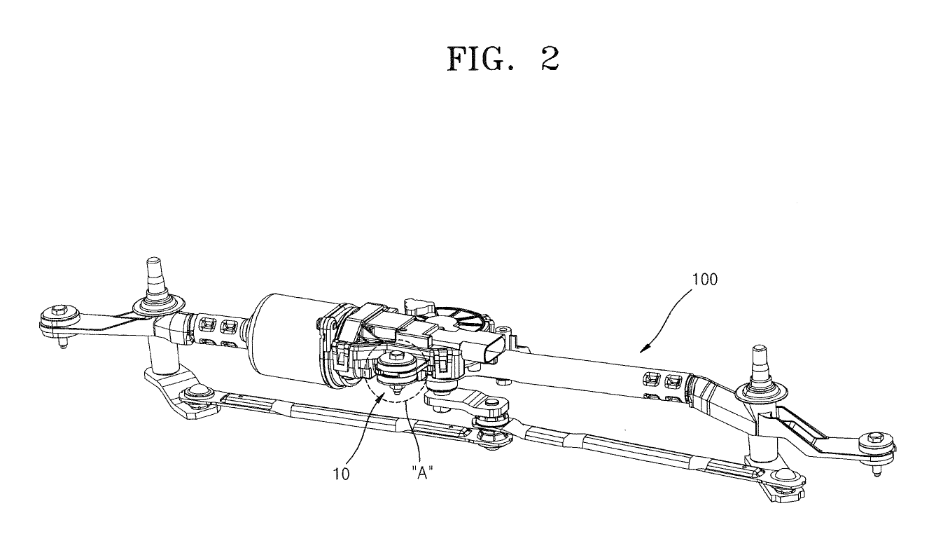

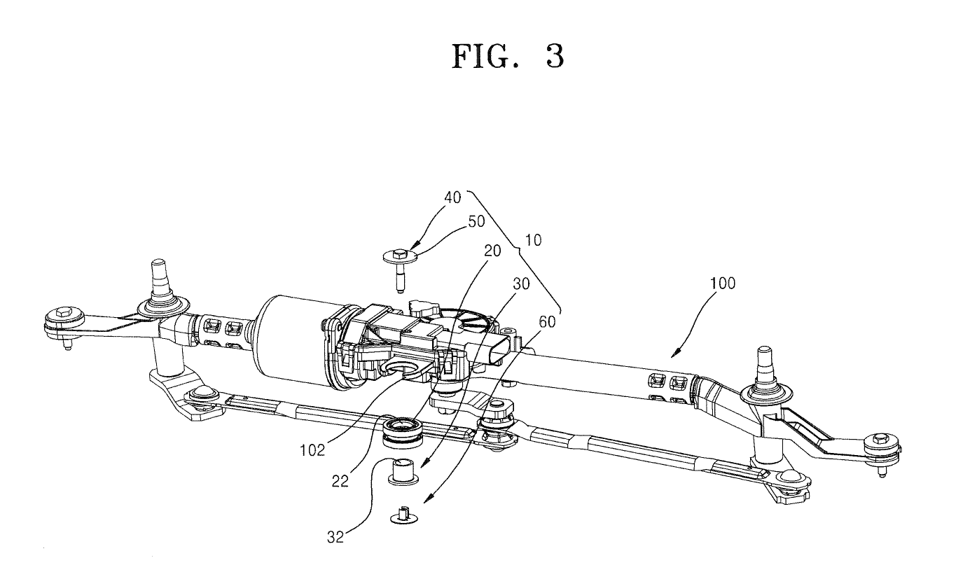

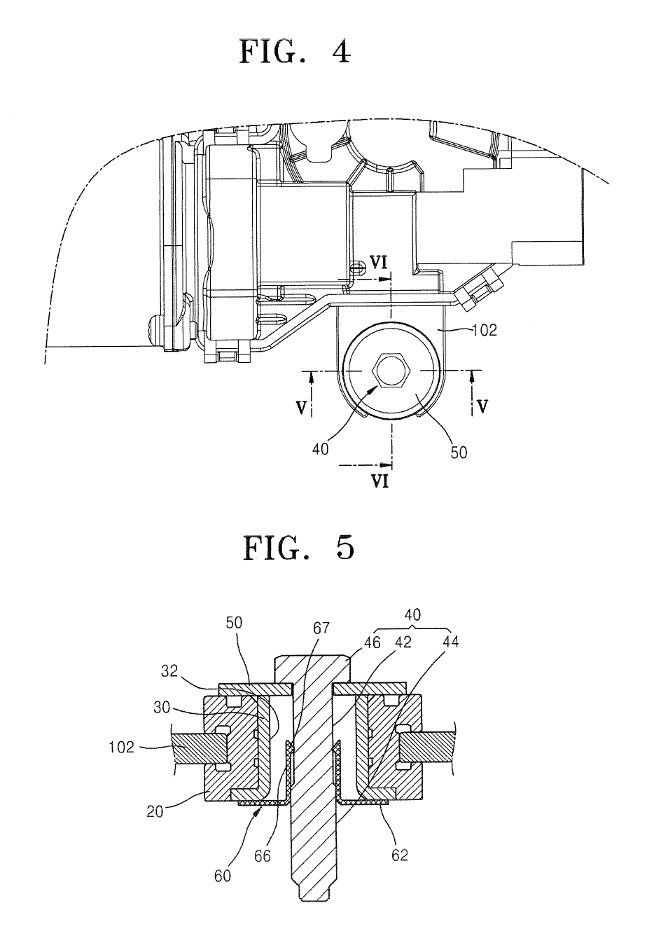

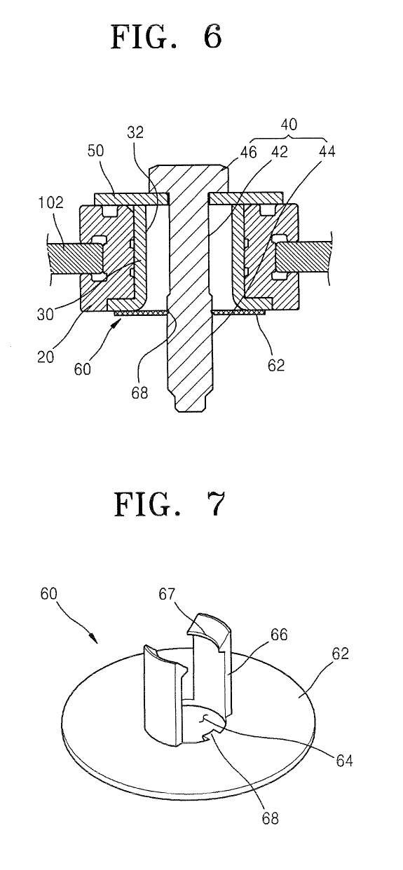

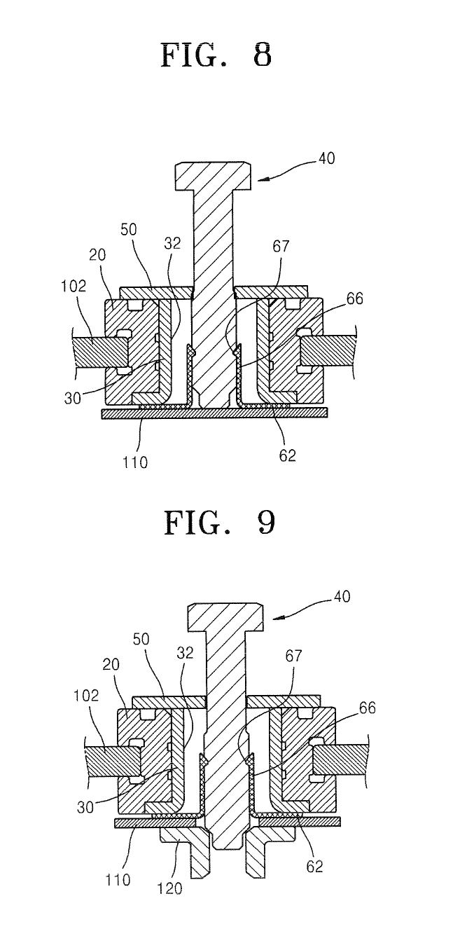

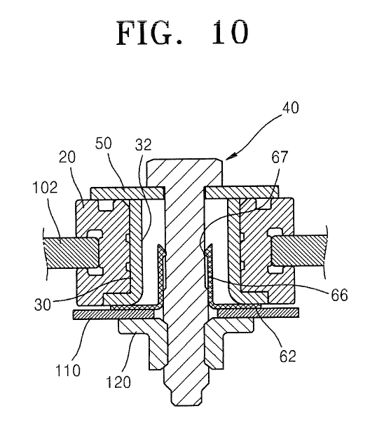

FIG. 2 is a diagram showing a wiper device 100 in which a bolt assembly 10 according to an embodiment of the present invention is adopted. FIG. 3 is a perspective view showing that the bolt assembly 10 is disassembled from the wiper device 100 illustrated in FIG. 2. FIG. 4 is a schematic plan view of portion “A” illustrated in FIG. 2. FIG. 5 is a cross-sectional view taken along line V-V illustrated in FIG. 4. FIG. 6 is a cross-sectional view taken along line VI-VI illustrated in FIG. 4. FIG. 7 is a schematic perspective view of a separation prevention member 60 illustrated in FIG. 5. FIG. 8 is a diagram for explaining a separation prevention operation in a case where the bolt assembly 10 illustrated in FIG. 2 contacts a car body panel 110. FIGS. 9 and 10 are diagrams sequentially showing a process of assembling a wiper device to a car body by using the bolt assembly 10 illustrated in FIG. 2.

Referring to FIGS. 2 to 9, the bolt assembly 10 for a wiper device of a vehicle is used to fix the wiper device 100 of a vehicle to the car body panel 110. The bolt assembly 10 is coupled to the wiper device 100 for a vehicle.

In more detail, the bolt assembly 10 includes a damping member 20, a bush 30, a bolt member 40, a washer 50, and the separation prevention member 60.

A penetration hole 22 is formed in the central portion of the damping member 20. The damping member 20 includes a groove formed in the outer circumference surface thereof, as illustrated in FIG. 3, and thus, is detachably coupled to an assembly unit 102 disposed in the wiper device 100. The assembly unit 102 has a form of a hole opened in one direction. The damping member 20 is formed of, for example, a flexible material such as rubber or the like.

The bush 30 may be formed of a metal material such as carbon steel, stainless steel, aluminum alloy, or the like. The bush 30 includes a hollow 32. The bush 30 is correspondingly fit to an inner circumference surface of the penetration hole 22, and thus is fixed to the damping member 20. A flange is disposed in a lower portion of the bush 30, and is accommodated in the groove formed in a surface of a lower portion of the damping member 20.

The bolt member 40 is used to directly fix the wiper device 100 to the car body panel 10. The bolt member 40 includes a pillar portion 42, a male screw portion 44, and a head portion 46. The pillar portion 42 has a shape of a rod, and a cross section of the pillar portion 42 has a circular form. The male screw portion 44 is formed in a lower portion of the pillar portion 42. When the pillar portion 42 is divided into two portions in the longitudinal direction thereof, the male screw portion 44 is formed in a portion corresponding to a lower portion of the two portions. In more detail, the male screw portion 44 is formed on the outer circumference surface of a portion protruding under the lower surface of the hollow 32 when the bolt member 40 is fully assembled in the bush 30. A portion where the male screw portion 44 is formed has an external diameter larger than that of the pillar portion 42 where the male screw portion 44 is not formed.

The bolt member 40 is disposed to penetrate the hollow 32 of the bush 30. That is, the bolt member 40 is formed to have an external diameter smaller than an internal diameter of the hollow 32 to accept an assembly tolerance when assembled onto the car body panel 110. The head portion 46 is formed in an upper portion of the pillar portion 42 and has an external diameter larger than that of the pillar portion 42. An outer circumference surface of the head portion 46 may have a form of a tetragon, a hexagon, or an octagon. The head portion 46 is combined with a tool when fixing the wiper device 100 to the car body panel 110 to thus facilitate the rotation of the bolt member 40.

The washer 50 has a form in which a hole is formed in a central portion of a circular plate. The washer 50 is assembled to the bolt member 40 to prevent the bolt member 40 from being separated to a lower side of the hollow 32. The washer 50 is caught on an upper surface of the bush 30 to thereby prevent the head portion 46 from being separated in a downward direction of the bush 30.

The separation prevention member 60 plays a key role. The separation prevention member 60 is prepared to prevent the bolt member 40 from being separated to an upper side of the hollow 32. The separation prevention member 60 is assembled to the bolt member 40 and is caught on a lower surface of the bush 30 to thus prevent the bolt member 40 from being separated in an upward direction of the hollow 32. Below, a structure of the separation prevention member 60 is described in more detail.

The separation prevention member 60 includes a flange portion 62, a pressure portion 66, a hook 67, and an auxiliary hook 68.

The flange portion 62 is formed to be caught on the lower surface of the bush 30. The flange portion 62 may have a shape similar to that of the washer 50. That is, the flange portion 62 includes an assembly hole 64, through which the male screw portion 44 of the bolt member 40 penetrates, in the central portion of the flange portion 62.

The pressure portion 66 extends from the flange portion 62 toward the longitudinal direction of the bolt member 40. The pressure portion 66 is formed in a form of a cantilever, and a free end portion thereof is formed to surround the male screw portion 44 of the bolt member 40 while partially pressuring the male screw portion 44. A plurality of pressure portions may be disposed. As illustrated in FIG. 7, in the current embodiment, a pair of pressure portions that are spaced apart from each other are disposed. In this case, the pair of pressure portions may be disposed spaced apart from each other along an inner circumference surface of the assembly hole 64 when seen along the longitudinal direction of the bolt member 40. That is, the pair of pressure portions may be disposed spaced apart from each other along the circumference of the bolt member 40.

The hook 67 is formed on the upper portion of the pressure portion 66. The hook 67 has a form protruding toward the male screw portion 44. A typical form of the hook 67 is illustrated in FIG. 7, and a structure of the hook 67 may be easily understood with reference to FIG. 7.

The auxiliary hook 68 is formed to protrude from the inner circumference surface of the assembly hole 64 toward the male screw portion 44. In more detail, the auxiliary hook 68 is disposed on the opposite side of the hook 67 with respect to the longitudinal direction of the bolt member 40. That is, the hook 67 supports the upper portion of the male screw portion 44, and the auxiliary hook 68 supports the lower portion of the male screw portion 44. The auxiliary hook 68 is disposed so as not to overlap with the hook 67 when seen along the longitudinal direction of the bolt member 40. Disposing the hook 67 and the auxiliary hook 68 to not overlap with each other on a floor plan has an effect that an undercut does not occur in a mold when forming the hook 67 and the auxiliary hook 68 in the mold. A plurality of hooks may be formed, and similarly, a plurality of auxiliary hooks may be formed. In this case, the auxiliary hooks may be disposed so that positions of the auxiliary hooks do not overlap with positions of the hooks on a floor plan.

The separation prevention member 60 having the structure as described above is generally formed of synthetic resin, but may be formed of a metal material such as carbon steel, stainless steel, or the like. If the separation prevention member 60 is formed of a metal material, the hook 67 and the auxiliary hook 68 may be formed by a method such as caulking.

Below, an operational effect of the bolt assembly 10 is described in detail, for example, with respect to a process of transporting the wiper device 100, in which the bolt assembly 10 has been adopted, and a process of assembling the wiper device 100 to the car body panel 110.

The bolt assembly 10 needs to be assembled in a state as illustrated in FIG. 2. That is, the damping member 20 and the bush 30 are assembled together. Then, the bolt member 40 and the washer 50 are assembled together. A component in which the damping member 20 and the bush 30 are assembled is assembled to the assembly unit 102 prepared in the wiper device 100. The bolt member 40 assembled together with the washer 50 is disposed so as to penetrate the hollow 32 of the bush 30. In this state, the separation prevention member 60 is received by the male screw portion 44 of the bolt member 40 from the lower side of the bush 30. As a result, as illustrated in FIG. 5, the washer 50 contacts the upper surface of the bush 30. In addition, the flange portion 62 of the separation prevention member 60 contacts the lower surface of the bush 30. As illustrated in FIG. 5, the pressure portion 66 of the separation prevention member 60 and the hook 67 pressure an upper portion of the pillar portion 42 including the male screw portion 44. In addition, as illustrated in FIG. 6, the auxiliary hook 68 of the separation prevention member 60 pressures a lower portion of the male screw portion 44, and thus, the separation prevention member 60 is not separated from the bolt member 40. In this manner, the washer 50 and the separation prevention member 60 strongly support the upper surface of the bush 30 and the lower surface of the bush 30, respectively, during transportation of the wiper device 100 in which the bolt assembly 10 has been adopted, and thus, the bolt member 40 is prevented from being separated from the wiper device 100.

Next, a case in which a vehicle assembly manufacturer assembles the wiper device 100, in which the bolt assembly 10 has been adopted, onto the car body panel 110 is described below. FIGS. 9 and 10 are diagrams sequentially showing a process of assembling the wiper device 100 onto the car body panel 100. A welding nut 120 is disposed under the car body panel 110, and a hole for assembling is formed in a portion of the car body panel 110 to which the welding nut 120 is attached. As illustrated in FIG. 9, the assembly unit 102 of the wiper device 100 approaches the car body panel 110 from the upper side of the car body panel 110. In this process, the male screw portion 44 of the bolt member 40 penetrates the hole prepared in the car body panel 110, and thus is disposed in the entrance of the welding nut 120. In this state, the head portion 46 of the bolt member 40 is rotated and pressed by using a tool. Thus, the bolt member 40 is assembled in a state as shown in FIG. 10 by the welding nut 120. In this process, since the pressure portion 66 is elastic, the assembly process is not disturbed when the male screw portion 44 is assembled onto the welding nut 120. In this manner, the separation prevention member 60 does not disturb the process of assembling the wiper device 100 onto the car body panel 110, and also prevents the bolt member 40 from being separated from the bush 30 in an unexpected situation as in FIG. 8. FIG. 8 shows a case where the assembly unit 102 of the wiper device 100 is placed at a location that is not an assembly area of the car body panel 110 due to an operator's mistake. Referring to FIG. 8, if the head portion 46 of the bolt member 40 is likely to separate to the upper side of the bush 30 as the lower portion of the bolt member 40 is supported by the car body panel 110, the pressure portion 66 and the hook 67 of the separation prevention member 60 support the male screw portion 44 to thus prevent the bolt member 40 from completely separating to the upper side of the bush 30.

In this manner, a bolt assembly according to an embodiment of the present invention is detachably assembled onto a wiper device, and prevents a bolt from being separated from the wiper device unexpectedly. Thus, the bolt assembly according to an embodiment of the present invention prevents the bolt from being lost in a process of transporting the wiper device having a module form or a process of assembling the wiper device onto a car body, thereby improving the efficiency of car assembly. While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A bolt assembly for a wiper device of a vehicle, the bolt assembly comprising:
a damping member in which a penetration hole is formed in a central portion thereof and that is detachably coupled to an assembly unit disposed in the wiper device, wherein the damping member comprises a rubber material;
a bush that correspondingly fits an inner circumference surface of the penetration hole to be fixed to the damping member and comprises a hollow;
a bolt member that is disposed to penetrate the hollow of the bush, has an external diameter smaller than an internal diameter of the hollow, wherein the bolt member comprises a male screw portion formed on an outer circumference surface of a portion protruding under a lower surface of the hollow;
a washer that is assembled to the bolt member to prevent the bolt member from being separated to a lower side of the hollow and thus is caught on an upper surface of the bush; and
a separation prevention member that is assembled to the bolt member to prevent the bolt member from being separated to an upper side of the hollow and thus is caught on a lower surface of the bush,
wherein the separation prevention member comprises:
a flange portion that is caught on the lower surface of the bush and comprises an assembly hole, through which the male screw portion of the bolt member penetrates, in the central portion of the flange portion; and
a pressure portion that extends from the flange portion toward the longitudinal direction of the bolt member and partially surrounds the male screw portion of the bolt member.

2. The bolt assembly of claim 1, wherein the separation prevention member further comprises a hook protruding toward the male screw portion, which is disposed on an upper portion of the pressure portion.

3. The bolt assembly of claim 2, wherein the separation prevention member further comprises an auxiliary hook that is formed to protrude from an inner circumference surface of the assembly hole toward the male screw portion and not to overlap with the hook when seen along the longitudinal direction of the bolt member.

4. The bolt assembly of claim 2, wherein the pressure portion comprises a plurality of pressure portions that are disposed spaced apart from each other along the circumference of the bolt member.

5. The bolt assembly of claim 3, wherein the auxiliary hook comprises a plurality of auxiliary hooks
